(19) United States
(12) Patent Application Publication
(10) Pub. No.: US 2007/0238490 A1
(43) Pub. Date: Oct. 11, 2007

(54) WIRELESS MULTI-MICROPHONE SYSTEM FOR VOICE COMMUNICATION

(75) Inventors: Mats MYRBERG, Seattle, WA (US); Manpreet Khaira, Portland, OR (US)

Correspondence Address: JOSEPH P. CURTIN, 1469 N.W. MORGAN LANE, PORTLAND, OR, 97229, US

(73) Assignee: Avnera Corporation, Beaverton, OR (US)

(21) Appl. No.: 11/279,340

(22) Filed: Apr. 11, 2006

(51) Int. Cl. H04M 1/00

(52) U.S. Cl. 455/569.1; 455/575.2

(57) ABSTRACT

A wireless communication system includes a wireless terminal and a host device. The wireless terminal includes a transceiver and a processor. The transceiver of the wireless terminal transmits electrical audio signals output from a plurality of microphones over a wireless communication link for enhancement processing, such as noise-cancellation processing, echo-cancellation processing, and/or sidetone processing, at the host device. The wireless communication link can be an electromagnetic-based wireless communication link, a light-based wireless communication link and/or a magnetic-induction-based wireless communication link. The transceiver of the wireless terminal further receives from the wireless communication link enhancement-processed signals based on the electrical audio signals. The processor of the wireless terminal uses the enhancement-processed signals to output an enhanced audio output signal from the terminal device.

### BACKGROUND

The subject matter disclosed herein relates to communication devices. More particularly, the subject matter disclosed herein relates to wireless communication devices for voice, audio and audio/video (A/V) content.

### SUMMARY

The subject matter disclosed herein provides a wireless communication system having a wireless terminal and a host device. The wireless terminal includes a transceiver and a processor. The transceiver of the wireless terminal transmits electrical audio signals over a wireless communication link for enhancement processing, such as noise-cancellation processing, echo-cancellation processing, sidetone processing, equalization processing, vocoding processing, voice-activity detection processing, sibilance removal processing, ducking processing, harmonization processing and/or feedback processing, at the host device. The electrical audio signals are output from a plurality of microphone transducer devices. The wireless communication link can be an electromagnetic-based wireless communication link, a light-based wireless communication link and/or a magnetic-induction-based wireless communication link. The transceiver of the wireless terminal further receives from the wireless communication link enhancement-processed signals based on the electrical audio signals. The processor of the wireless terminal, which can be an analog-based processor, a microprocessor-based device, a microcontroller-based device, an embedded processing device, and/or a state-machine processing device, uses the enhancement-processed signals to output an enhanced audio output signal from the terminal device. The host device includes a wireless transceiver and a processor. The transceiver of the host device receives the electrical audio signals from the wireless terminal over the wireless communication link. The processor of the host device, which can be an analog-based processor, a microprocessor-based device, a microcontroller-based device, an embedded processing device, and/or a state-machine processing device, enhancement processes the received electrical audio signals for generating the enhancement-processed signals based on the received electrical audio signals. Additionally, the processor of the host device may process the received electrical audio signals together with electrical audio signals that host device receives from a telecommunications network, such as from the Internet, a Public-Switched Telephone Network (PSTN), a mobile telephone system, and/or an audio content source and/or an audio/video (A/V) content source. The wireless transceiver of the host device further transmits the enhancement-processed signals to the wireless terminal over the wireless communication link and/or the host device transmits the enhancement-processed signals as a signal that is output to a telecommunications network, such the Internet, a PSTN or a mobile telephone system, and/or an audio content source and/or an AV content source.

### BRIEF DESCRIPTION OF THE DRAWINGS

The subject matter disclosed herein is illustrated by way of example and not by limitation in the accompanying figures in which like reference numerals indicate similar elements and in which:

FIG. 1 depicts a functional block diagram of an illustrative embodiment of a wireless multi-microphone communication system according to the subject matter disclosed herein; and

FIG. 2 depicts an illustrative process flow diagram according to the subject matter disclosed herein.

### DETAILED DESCRIPTION

The subject matter disclosed herein relates to a wireless system for voice communication that employs multiple (two or more microphones) in a voice communication device for enabling processing of the audio streams from the multiple microphones at a receiving host device. In one illustrative embodiment, the subject matter disclosed herein relies on two or more microphones being integrated into a wireless voice communication device (terminal device) such as a headset or telephone. The captured microphone data is transmitted to a host device over a wireless link that uses multiple data streams to transmit microphone data in order to perform, for example, noise suppression and/or echo cancellation enhancement processing, equalization (EQ) processing, vocoding processing, voice-activity detection processing, de-essing (sibilance removal) processing, ducking processing (i.e., lowering the volume of a selected microphone feed based on the volume of another microphone feed), harmonization processing (i.e., harmonization creation based on selected microphone feeds), and/or feedback processing. In another illustrative embodiment, the captured microphone data may also be processed together with the electrical audio signals that are received from a telecommunications network, such as the Internet, a PSTN or a mobile telephone system, and/or an audio content source and/or an A/V content source. In still another illustrative embodiment, other enhancement signal processing could also be performed at the host device that, for example, enhance the voice quality sent and received over the wireless link, such as by enhancing the tonal quality of the voice data. In yet another illustrative embodiment, the enhancement signal processing is performed at the host device with assistance from the wireless device. In a further illustrative embodiment, the enhancement-processed signals are transmitted to a telecommunications network, such as the Internet, a PSTN or a mobile telephone system, and/or an audio content source and/or an A/V content source and/or are transmitted from the host device to the terminal device.

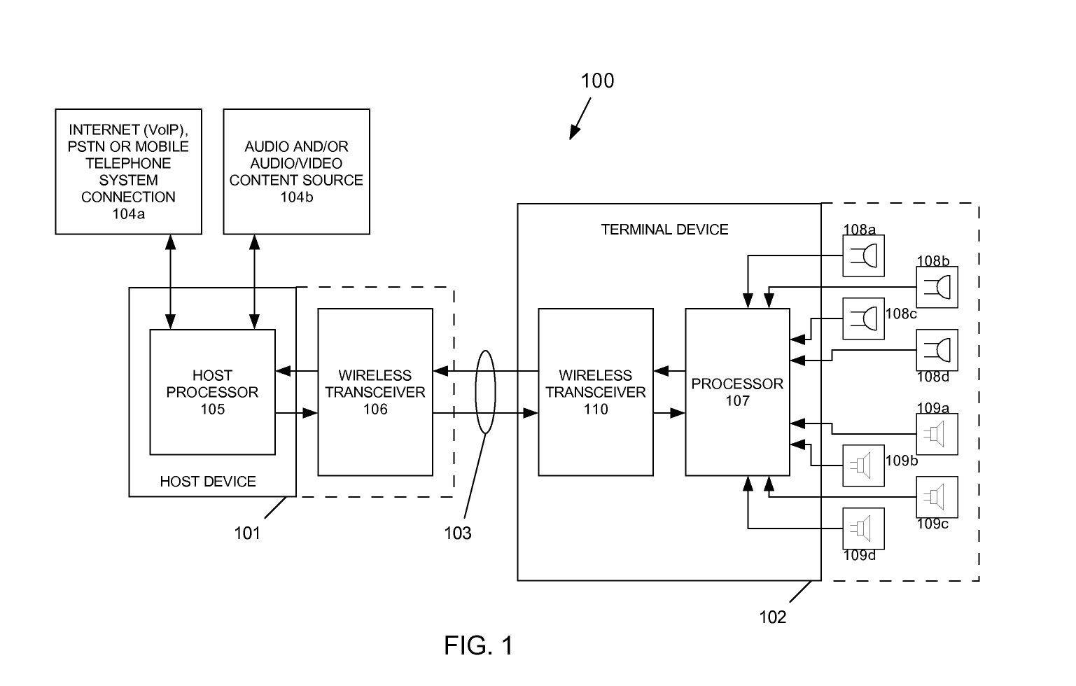

FIG. 1 depicts a functional block diagram of an illustrative embodiment of a wireless multi-microphone communication system 100 according to the subject matter disclosed herein. System 100 includes a host device 101 that is coupled to a terminal device 102 over a wireless communication link 103. Generally, host device 101 has significantly more processing capability than terminal device 102. In one illustrative embodiment, host device 101 is a telephone and terminal device 102 is a wireless headset. In another illustrative embodiment, host device 101 is telephone base station and terminal device 102 is a wireless telephone set that operates with the telephone base station. For both of these two illustrative embodiments, host device 101 is coupled to a telecommunications network 104a, such as the Internet for a Voice over an IP (VoIP) telephone system, a Public-Switched Telephone Network (PSTN), or a mobile telephone system. In yet another illustrative embodiment, host device 101 is coupled to an audio content source and/or audio/video (A/V) content source 104b alternatively to or in addition to a telephone network 104b. For this illustrative embodiment, terminal device 102 provides ambient noise-suppression, thereby enhancing the listening quality of the audio content and/or A/V content.

Host device 101 includes a host processor 105 operatively coupled to a wireless transceiver 106 in a well-known manner. Host processor 105 can be an analog-based processor, a microprocessor-based device, a microcontroller-based device, an embedded processing device, and/or a state-machine processing device and operates in a well-known manner to provide selected control and signal processing functionality (i.e., signal processing in the analog and/or digital domain) that depends on the specific application and environment for system 100. Wireless transceiver 106 operates in a well-known manner to transmit and receive communication signals over communication link 103, as described further below. In one illustrative embodiment, host processor 105 and wireless transceiver 106 are part of a single component within host device 101. In another illustrative embodiment, host processor 105 and wireless transceiver 106 are separate components that are co-located in host device 101. In yet another illustrative embodiment, wireless transceiver 106 is remotely located from host processor 105, such as part of peripheral equipment, as depicted by the dashed line around wireless transducer 106.

Terminal device 102 includes a processor 107, a plurality of microphone transducer devices 108a-108d, a plurality of speaker transducer devices 109a-109d, and a wireless transceiver 110. Processor 107 is operatively coupled to microphone transducer devices 108a-108d and speaker transducer devices 109a-109d in a well-known manner. Processor 107 is also operatively coupled to wireless transceiver 110 in a well-known manner. Processor 107 can be an analog-based processor, a microprocessor-based device, a microcontroller-based device, an embedded processing device, and/or a state-machine processing device and operates in a well-known manner to provide selected control and signal processing functionality (i.e., control and/or signal processing in the analog and/or digital domain) that depends on the specific application and environment for system 100. In one illustrative embodiment, processor 107 and wireless transceiver 110 are part of a single component within terminal device 102. In another illustrative embodiment, processor 107 and wireless transceiver 110 are separate components that are co-located in terminal device 102. In yet another illustrative embodiment, wireless transceiver 110 is remotely located from processor 107, such as part of peripheral equipment of terminal device 102.

Microphone transducer devices 108a-108d can be any type of microphone transducer device, including, but not limited to, a capacitor- or condenser-type of microphone, an electret-capacitor-type of microphone, a dynamic-type microphone, a ribbon-type microphone, a carbon-type microphone, a piezo-type microphone, a laser-type microphone, a pressure-gradient-type of microphone, a lavalier-type of microphone, a contact-type microphone (i.e., a bone-conduction-type of microphone), a parabolic-type of microphone. While terminal device 102 is shown including four microphone transducer devices 108, it should be understood that terminal device 102 can include two or more microphone transducer devices 108. Further, it should be understood that microphone transducer devices 108 could each be a different type of microphone transducer device or a combination of the same type and/or of different types of microphone transducer devices. Similarly, speaker transducer devices 109a-109d can be any type of speaker transducer device, and while terminal device 102 is shown including four speaker transducer devices 109, terminal device 102 can have one or more speaker transducer devices 109. In one illustrative embodiment, microphone transducer devices 108 and speaker transducer devices 109 are co-located with processor 107 in terminal device 102. In another illustrative embodiment, microphone transducer devices 108 and/or speaker transducer devices 109 are remotely located from processor 107, such as part of peripheral equipment, as depicted by the dashed line around microphone transducer devices 108 and speaker transducer devices 109.

Wireless communication link 103 is any type of bi-directional wireless communication link, such as an electromagnetic-based communication link and/or a light-based communication link. In one illustrative embodiment, wireless communication link 103 is a radio-frequency (RF) communication link. In another illustrative embodiment, wireless communication link is an infrared (IR) communication link. In yet another illustrative embodiment, wireless communication link 103 is a magnetic-induction communication link. In still another illustrative embodiment, wireless communication link 103 is a combination electromagnetic-based and light-based communication link. Further, wireless communication link 103 can be a half-duplex or a full duplex communication link. Further still, wireless communication link 103 can have different types of forward and reverse communication links. For example, one link direction could be an electromagnetic-based communication link while the other link direction could be a light-based communication link. In yet another illustrative embodiment, wireless communication link could be a TDMA-based communication link, a FDMA-based communication link and/or a CDMA-based communication link.

In operation, microphone transducers devices 108 convert audio sound waves to electrical audio signals in a well-known manner. The electrical audio signals produced by selected microphone transducer devices 108 are coupled to processor 107, which, in turn, couples the electrical signals to wireless transceiver 110. Processor 107 may provide appropriate signal processing, such as conditioning and/or formatting the audio signals for transmission by wireless transceiver 110. Wireless transceiver 110 transmits the electrical audio signals over communication link 103 to wireless transceiver 106 of host device 101. In one illustrative embodiment, wireless transceivers 106 and 110 may include medium access control (MAC) and/or encryption functionality.

Wireless transceiver 106 of host device 101 receives the transmitted audio signals from terminal device 102 and couples the received audio signals to host processor 105 for enhancement processing. In one illustrative embodiment, host processor 105 performs enhancement processing, such as noise-reduction/noise-cancellation processing, equalization (EQ) processing, vocoding processing, voice-activity detection processing, de-essing (sibilance removal) processing, ducking processing (i.e., lowering the volume of a selected microphone feed based on the volume of another microphone feed), harmonization processing (i.e., harmonization creation based on selected microphone feeds) and/or feedback processing, on the received audio signals and couples the enhancement-processed signals to wireless transceiver 106 for transmission back to terminal device 102. In another illustrative embodiment, processor 105 of host device 101 may additionally process the received electrical audio signals together with the electrical audio signals that are received from telecommunications network 104a, and/or audio and/or A/V content source 104b. In another illustrative embodiment, the enhancement-processed signals are transmitted to telecommunications network 104a, and/or audio and/or A/V content source 104b, and/or are transmitted from host device 101 to terminal device 102.

Wireless transceiver 110 of terminal device 102 receives and couples the processed signals to processor 107. Processor 107, in turn, couples the processed signals to selected speaker transducer devices 109, thereby providing an enhanced audio response for a user of terminal device 102. In one illustrative embodiment, the processed signals are coupled to selected speaker transducer devices 109 without being combined with the electrical audio signals that are initially coupled to processor 107 from selected microphone transducer devices 108. In another illustrative embodiment, the processed signals are coupled to selected speaker transducer devices 109 after being coupled with at least a portion of the electrical audio signals that are initially coupled to processor 107 from selected microphone transducer devices 108. In yet another illustrative embodiment, the enhanced audio response includes a noise reduction that is based on audio signals detected by selected microphone transducer devices 108. In a further illustrative embodiment, the enhanced audio response includes echo cancellation. In still another illustrative embodiment, the enhanced audio response includes sidetone processing. In yet other illustrative embodiments, the enhanced audio response can include equalization processing, vocoding processing, voice-activity detection processing, sibilance removal processing, ducking processing, harmonization processing and/or feedback processing.

In one illustrative embodiment, substantially all enhancement processing is performed by host device 101. In another illustrative embodiment, terminal device 102 can provide some enhancement processing to assist the enhancement processing performed by host device 101. Host processor 105 can also generate control signals for controlling terminal device 102 in order to optimize processing at host device 101. For example, control signals could be transmitted to terminal device 102 for selecting the electrical signals output by particular microphone transducer devices 108 and/or adjust the gain of selected microphone transducer devices 108. In another illustrative embodiment, control signals could be transmitted from host device 101 to terminal device 102 for controlling the volume of selected speaker transducer devices 109.

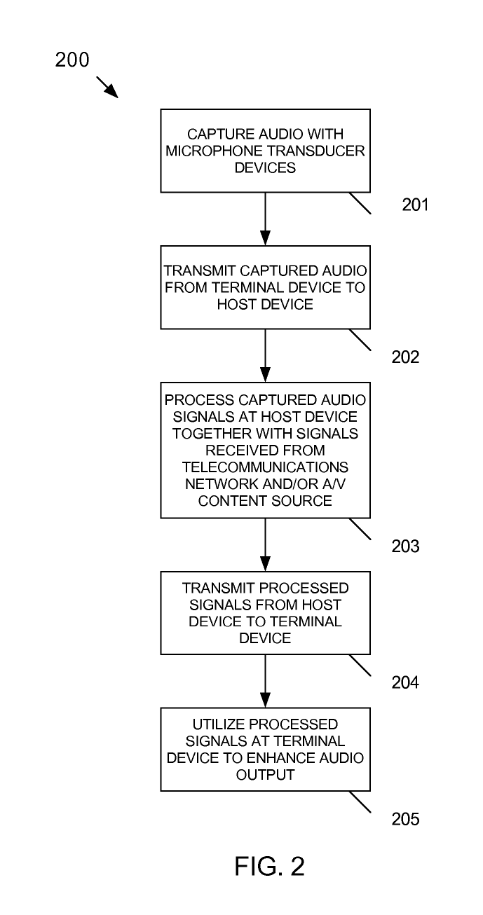

FIG. 2 depicts an illustrative process flow diagram 200 according to the subject matter disclosed herein. At step 201, audio signals are captured by selected microphone transducer devices 108. At step 202, the captured audio signals are transmitted from terminal device 102 to host device 101. At step 203, the captured audio signals are processed at host device 101 together with electrical audio signals that are received from telecommunications network 104a, and/or audio content source and/or A/V content source 104b. In one illustrative embodiment, the captured audio signals are processed without using any electrical audio signals that are received from telecommunications network 104a, and/or audio content and/or AV content source 104b. At step 204, the processed signals are transmitted from host device 101 to terminal device 102. In one illustrative embodiment, the processed signals are transmitted to telecommunications network 104a, and/or audio content source and/or A/V content source 104b and/or are transmitted from host device 101 to terminal device 102. At step 205, the processed signals are utilized by terminal device 102 to enhance the audio output of selected speaker transducer devices 109.

Although the foregoing disclosed subject matter has been described in some detail for purposes of clarity of understanding, it will be apparent that certain changes and modifications may be practiced that are within the scope of the appended claims. Accordingly, the present embodiments are to be considered as illustrative and not restrictive, and the subject matter disclosed herein is not to be limited to the details given herein, but may be modified within the scope and equivalents of the appended claims.

What is claimed is:

1. A wireless terminal, comprising:
a transceiver transmitting electrical audio signals over a wireless communication link for enhancement processing at a location that is remote from the wireless terminal, the electrical audio signals being output from a plurality of microphone transducer devices, the transceiver further receiving from the wireless communication link enhancement-processed signals based on the electrical audio signals; and
a processor using the enhancement-processed signals to output an enhanced audio output signal from the terminal device.

2. The wireless terminal according to claim 1, wherein the enhancement processing is one of a noise-cancellation processing, an echo-cancellation processing, a sidetone processing, equalization processing, vocoding processing, voice-activity detection processing, sibilance removal processing, ducking processing, harmonization processing, and feedback processing.

3. The wireless terminal according to claim 1, further comprising a plurality of microphone transducer devices.

4. The wireless terminal according to claim 1, further comprising at least one speaker transducer device coupled to the enhanced audio output signal.

5. The wireless terminal according to claim 1, wherein the wireless transceiver further receives control signals for controlling the processor.

6. The wireless terminal according to claim 1, wherein the wireless communication link is one of an electromagnetic-based wireless communication link, a light-based wireless communication link and a magnetic-induction-based wireless communication link.

7. The wireless terminal according to claim 1, wherein the processor performs one of a portion of the enhancement processing and none of the enhancement processing.

8. The wireless terminal according to claim 1, wherein the enhanced audio output signal is one of an audio output signal and an audio/visual output signal.

9. The wireless terminal according to claim 1, wherein the enhancement-processed signals are based at least one of the electrical audio signals transmitted by the transceiver over the wireless communication link, electrical audio signals received from a telephone network, electrical audio signals received from a content source, and electrical audio/video signals received from a content source.

10. The wireless terminal according to claim 1, wherein the processor is one of an analog-based processor, a microprocessor-based device, a microcontroller-based device, an embedded processing device, and a state-machine processing device.

11. The wireless terminal according to claim 1, further comprising a host device remotely located from the wireless terminal and coupled to the terminal device through the wireless communication link, the host device comprising:
a host wireless transceiver receiving the electrical audio signals from the wireless terminal over the wireless communication link; and
a host processor enhancement processing the received electrical audio signals for generating enhancement-processed signals based on the received electrical audio signals,
the host wireless transceiver further transmitting the enhancement-processed signals to the wireless terminal over the wireless communication link.

12. The wireless terminal according to claim 11, wherein the enhancement processing is one of a noise-cancellation processing, an echo-cancellation processing, a sidetone processing, equalization processing, vocoding processing, voice-activity detection processing, sibilance removal processing, ducking processing, harmonization processing and feedback processing.

13. The wireless terminal according to claim 11, wherein the host wireless transceiver further transmits control signals over the wireless communication link for controlling the wireless terminal.

14. The wireless terminal according to claim 11, wherein the wireless communication link is one of an electromagnetic-based wireless communication link, a light-based wireless communication link and a magnetic-induction-based wireless communication link.

15. The wireless terminal according to claim 11, wherein the enhancement-processed signals are based at least one of the electrical audio signals transmitted by the transceiver over the wireless communication link, electrical audio signals received from a telecommunications network, electrical audio signals received from a content source, and electrical audio/video signals received from a content source.

16. The wireless terminal according to claim 11, wherein the host processor further uses the enhancement-processed signals to output an enhanced audio output signal to one of a telecommunications network, an audio content source and an audio/video content source.

17. The wireless terminal according to claim 11, wherein the host processor is one of an analog-based processor, a microprocessor-based device, a microcontroller-based device, an embedded processing device, and a state-machine processing device.

18. A wireless host device, comprising
a host wireless transceiver receiving the electrical audio signals from a wireless terminal over a wireless communication link, the wireless terminal being located remotely from the wireless host device, the electrical audio signals being generated by a plurality of microphone transducer devices associated with the wireless terminal; and
a host processor enhancement processing the received electrical audio signals for generating enhancement-processed signals based on the received electrical audio signals,
the host wireless transceiver further transmitting the enhancement-processed signals to the wireless terminal over the wireless communication link.

19. The wireless host device according to claim 18, wherein the enhancement processing is one of a noise-cancellation processing, an echo-cancellation processing, a sidetone processing, equalization processing, vocoding processing, voice-activity detection processing, sibilance removal processing, ducking processing, harmonization processing and feedback processing.

20. The wireless host device according to claim 18, wherein the host wireless transceiver further transmits control signals over the wireless communication link for controlling the wireless terminal.

21. The wireless host device according to claim 18, wherein the wireless communication link is one of an electromagnetic-based wireless communication link, a light-based wireless communication link and a magnetic-induction-based wireless communication link.

22. The wireless host device according to claim 18, wherein the enhancement-processed signals are based at least one of the electrical audio signals transmitted by the transceiver over the wireless communication link, electrical audio signals received from a telecommunications network, electrical audio signals received from a content source, and electrical audio/video signals received from a content source.

23. The wireless host device according to claim 18, wherein the host processor further uses the enhancement-processed signals to form an enhanced audio output signal for one of a telecommunications network, an audio content source and an audio/video content source.

24. The wireless host device according to claim 18, wherein the processor is one of an analog-based processor, a microprocessor-based device, a microcontroller-based device, an embedded processing device, and a state-machine processing device.

25. A method, comprising
generating electrical audio signals using a plurality of microphone transducer devices associated with a wireless terminal;
sending the electrical audio signals from the wireless terminal to a host device over a wireless communication link for enhancement processing at a location that is remote from the wireless terminal,
enhancement processing the received electrical audio signals at the host device for generating enhancement-processed signals based on the received electrical audio signals,
receiving from the wireless communication link at the wireless terminal the enhancement-processed signals based on the electrical audio signals; and
using the enhancement-processed signals at the wireless terminal to form an enhanced audio output signal for the terminal device.

26. The method according to claim 25, wherein the enhancement processing is one of a noise-cancellation processing, an echo-cancellation processing, a sidetone processing, equalization processing, vocoding processing, voice-activity detection processing, sibilance removal processing, ducking processing, harmonization processing and feedback processing.

27. The method according to claim 25, wherein the wireless communication link is one of an electromagnetic-based wireless communication link, a light-based wireless communication link and a magnetic-induction-based wireless communication link.

28. The method according to claim 25, wherein the enhancement-processed signals are based at least one of the electrical audio signals transmitted by the transceiver over the wireless communication link, electrical audio signals received from a telecommunications network, electrical audio signals received from a content source, and electrical audio/video signals received from a content source.

29. The method according to claim 25, further comprising using the enhancement-processed signals to form an enhanced audio output signal for use with one of a telecommunications network, an audio content source and an audio/video content source.

30. The method according to claim 25, wherein the enhancement processing is performed by one of an analog-based processor, a microprocessor-based device, a microcontroller-based device, an embedded processing device, and a state-machine processing device.
